(19) United States
(12) Patent Application Publication
(10) Pub. No.: US 2019/0188342 A1
(43) Pub. Date: Jun. 20, 2019

(54) METHODS AND APPARATUS FOR HAZARD ABATEMENT USING NORMALIZED EFFECT ANALYSIS

(71) Applicant: Raytheon Company, Waltham, MA (US)

(72) Inventors: Paul C. Hershey, Ashburn, VA (US); Marilyn W. Zett, Vienna, VA (US); Michael A. Cianciosi, Fairfax, VA (US); Brianne R. Hoppes, Westminster, CO (US)

(21) Appl. No.: 16/224,103

(22) Filed: Dec. 18, 2018

Related U.S. Application Data
(60) Provisional application No. 62/607,048, filed on Dec. 18, 2017.

(51) Int. Cl. G06F 17/50; G06N 7/00; G06F 17/11

(52) U.S. Cl. CPC G06F 17/5009; G06F 17/11; G06N 7/005

(57) ABSTRACT

Generally discussed herein are systems, devices, and methods for mitigating damage caused by a hazard. A method can include identifying at least two effects that, with some probability, at least partially mitigate the hazard, identifying one or more vulnerabilities of the hazard that are the target for an effect of the identified effects, for each hazard, vulnerability pair, identifying a respective hazard model that simulates a state of the hazard in response to the effect, identifying effect models that simulate the respective effects, normalizing each of the identified effect models to a common model and determining a confidence level for each parameter of each normalized model, and simulating combinations of effects by combining normalized models and recording their combined effect on the hazard and a corresponding combined confidence level for the normalized models.

### CROSS-REFERENCE TO RELATED APPLICATION

This application claims the benefit of priority to U.S. Provisional Patent Application Ser. No. 62/607,048, filed on Dec. 18, 2017, and titled “PRIORITIZATION OF CYBER EFFECTS IN MULTI-DOMAIN ENVIRONMENTS”, which is incorporated by reference herein in its entirety.

### TECHNICAL FIELD

Generally discussed herein are systems, devices, techniques, and machine-readable media for determining a response to a hazard. In some embodiments, multiple effects, from one or more domains, are normalized and combined to determine a net effect on the hazard. In some embodiments, effects from distinct domains can be combined to determine the net effect. A likelihood can be determined that indicates how likely it is that the effect(s), with determined confidence, will at least partially mitigate the hazard.

### TECHNICAL BACKGROUND

Hazard abatement approaches vary widely. For example, the Department of Defense (DoD) respond to a hazard in a manner very differently from the Federal Emergency Management Agency (FEMA). This is at least partially because, the hazards that the DoD and FEMA handle are very different. It is also because, no uniform method existed for analysis of effects applied against hazards. Previous approaches examine only a portion of a single domain. These approaches provide end-users with only partial results from which to make critical decisions. This problem is particularly difficult in the presence of cyber hazards where timely response is critical for system survival.

This problem has been approached for non-cyber hazards (e.g., kinetic weapons that explode) by prioritizing responses manually, following procedures that make use of information that resides in various standards and manuals (e.g., Joint Munitions Effectiveness Manuals (JMEMs)). These standards and manuals provide a means to manually compare kinetics effects with respect to their relative success at defeating or degrading kinetic hazards. However, these mechanisms lack uniformity with respect to the unique effect equations and their respective parameters. Therefore, they lack the ability to integrate and fuse together the results of the equations to provide one consistent result for multi-domain environments where multiple effects may be applied against one or more hazards over the temporal period of the hazard kill chain. Additionally, there exists no automated capability to derive the fused and integrated analysis within that multi-domain environment.

A Common Vulnerability Scoring System (CVSS) from the Compute Security Resource Center of the National Institute of Standards and Technology (NIST) provides an open framework for communicating characteristics and impacts of information technology (IT) vulnerabilities. The quantitative model of the CVSS ensures repeatable accurate measurement while enabling users to see the underlying vulnerability characteristics that were used to generate the scores. However, the basis for the results is subject matter experts answers to a series of questions. This leads to highly variable results not suitable for critical decision-making.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates, by way of example, a diagram of a hazard and hazard abatement scenario.

FIG. 2 illustrates, by way of example, a diagram of an embodiment of a method for hazard abatement.

FIG. 3 illustrates, by way of example, a data flow diagram of a system for hazard abatement.

FIG. 4 illustrates, by way of example, a diagram of a system for hazard abatement.

FIG. 5 illustrates, by way of example, a block diagram of an embodiment of a machine in the example form of a computer system within which instructions, for causing the machine to perform any one or more of the methodologies discussed herein, may be executed.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments can provide a structured methodology with which to analyze and prioritize effects, such as, within multi-domain environments. Innovative aspects can include: 1. New capability to integrate and fuse analysis for multiple, diverse effects, such as in a multi-domain environment. 2. Novel capability to normalize analytics equations) in accordance with industry and/or government standards. 3. New methods for deriving and applying mathematical functions for effects and hazard representations. 4. New methods for prioritizing effects based on success against targets derived from analysis results.

As discussed in the background, no structured and repeatable method exists for analysis of effects, or effects in different domains. The effects can be applied against one or more hazards over diverse media within multi-domain environments (e.g., wired & wireless networks on land, sea, and space for manufacturing, transportation, command and control (C2), and mission flight).

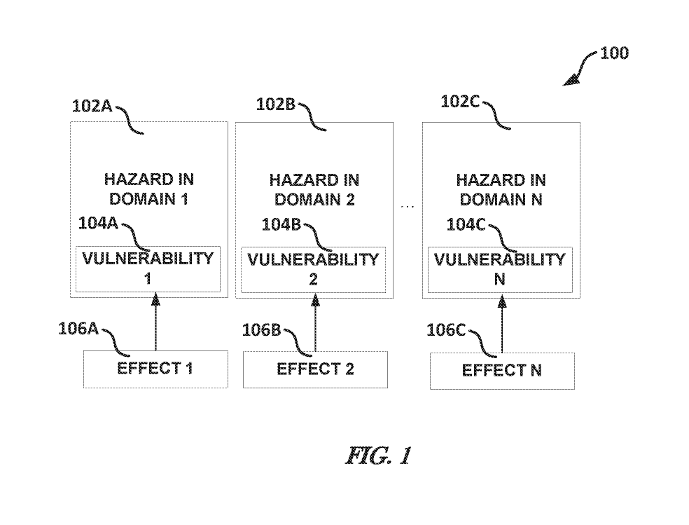

FIG. 1 illustrates, by way of example, a diagram of an embodiment of a hazard and hazard abatement scenario 100. The scenario 100 as illustrated includes a hazard in a first domain 102A, second domain 102B, and a third domain 102C. The hazard includes or may be associated with one or more vulnerabilities 104A, 104B, and 104C in each domain 102A-102C, respectively. The vulnerability 104A can be the same or different from the vulnerability 104B-104C. An effect 106A, 106B, 106C can exploit the vulnerability 104A-104C, respectively, such as to help mitigate the hazard in the domain 102A-102C.

The hazard can include one or more physical hazards to a person, place, or thing. The hazard can include a manned, unmanned, or natural physical hazard. A manned physical hazard can include, for example, a weapon, a vehicle, or the like. An unmanned physical hazard can include, for example, a drone, robot, turret, or the like. A natural hazard can include a hurricane, tornado, mudslide, earthquake, drought, flooding, or the like. As another example, a hazard may comprise a disease, an injury and/or a health disorder.

The vulnerability 104A-104C may comprise a weakness in the hazard that can be exploited, such as to help mitigate or prevent some of the damage caused by the hazard. For example, the vulnerability 104A-104C may include an eye of a hurricane, a jamming frequency, a speed of a tornado, a strength of an earthquake, a road on which a missile is to be carried, a transport vehicle carrying a missile, a battery life of a powered device, a human of a human-operated hazard, or the like.

The effect 106A-106C exploits the vulnerability 104A-104C to help mitigate the hazard. The effect 106A-106C can include structural reinforcement (e.g., boards, beams, sandbags, or the like), preemptive delivery of goods, a preemptive or counterattack (e.g., destruction of a vehicle, weapon, robot, drone, facility, person, frequency jamming, or the like), or the like.

The domain 102A-102C includes the environment in which the hazard is operating. The domain 102A-102C can include land, water, air, or wired or wireless channels for manufacturing, medium, network, transportation, combat, control, flight, operation, or the like.

The vulnerability 104A-104C can be same or different for a same hazard in different domains 102A-102C. For example, a hurricane over water can have different strengths and weaknesses than the same hurricane over land. An effect 106A-106C can have a different probability of success in mitigating the hazard in a different domain 102A-102C.

As previously discussed, prior approaches examine only a portion of a single domain. These approaches provide end-users with only partial results from which to make critical decisions. Various features of the embodiments described herein can analyze a hazard and corresponding vulnerability 104A-104C and effect 106A-106C (1) in multiple domains, or (2) with multiple effects 106A-106C. The techniques described herein can help determine a response to the hazard that can be effective in mitigating damage inflicted by the hazard. The described embodiments can provide confidence intervals that indicate to a user a likelihood that the effect 106A-106C will successfully mitigate a portion of the hazard. The embodiments can provide a framework in which diverse, distinct hazards, effects, and vulnerabilities can be analyzed simultaneously.

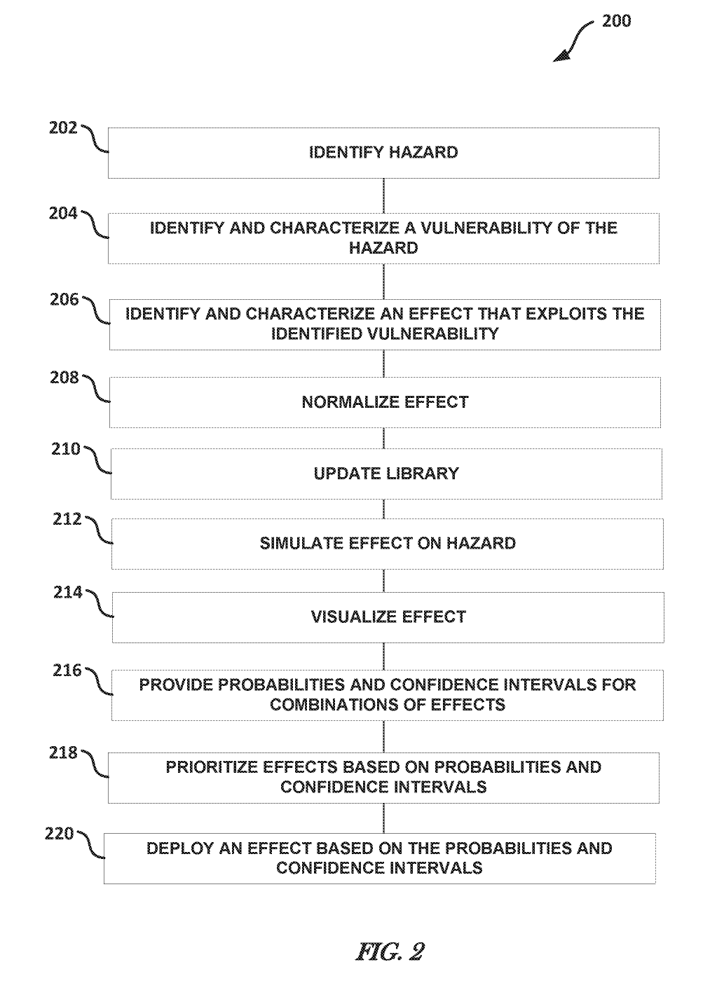

FIG. 2 illustrates, by way of example, a diagram of an embodiment of a method 200 for hazard-effect analysis. The method 200 as illustrated includes identifying a hazard, at operation 202; identifying and characterizing a vulnerability of the hazard, at operation 204; identifying and characterizing an effect that exploits the identified vulnerability, at operation 206; normalizing the identified effect, at operation 208; updating a library of effects, at operation 210; simulating the effect on the hazard, at operation 212; and visualizing the effect on the hazard, at operation 214. Further operations 216, 218 and 220 of the method 200 are also illustrated in FIG. 2. Some of the operations of the method 200 are optional and may or may not be performed as desired depending on the embodiment.

The operation 202 can include identifying a goal of mitigating the hazard, sometimes called a concept of operation (CONOP) or concept of employment (CONEMP). The operation 202 can include identifying a number and type of hazard. The goal can be chosen so that it is applicable under operation of an effect.

The operation 204 can include producing or identifying a mathematical model of the vulnerability associated with the hazard. The operation 204 can include determining that the vulnerability is consistent with the goal.

The operation 206 can include producing or identifying a mathematical model of the effect. The mathematical model is sometimes called a probability of defeat (pDefeat) equation. The mathematical model can indicate a probability, given environmental circumstances, a likelihood that the effect at least partially mitigates the hazard by exploiting the vulnerability. In some embodiments, the effect can be paired with one or more vulnerabilities, such that operation 204 is performed in selecting the effect at operation 204. The operation 206 can include identifying or producing one or more parameters, constraints, or the like of the mathematical model.

The operation 208 can include normalizing the effect model to a common probability model. The common probability model can be defined so that an effect, normalized to the common probability model (CPM), can be re-used for multiple hazards, vulnerabilities, or combining with other effects. In some embodiments, the common probability model can include a stochastic math model (SMM). Normalizing the mathematical model of the effect can include normalizing the parameters thereof so that they are consistent within the framework of the model. The operation 208 can include determining or identifying a confidence level or variability in a given parameter.

An example of a mathematical model for the probability of success (Psuccess) of an effect (such as an interceptor) on a hazard (such as a missile) is provided:

P_{success}=P_{ES}*P_{CS}*P_{REL}*P_{CTS}*P_{FOV}*P_{DIV} Equation 1

In Equation 1, P_{ES} indicates a likelihood of combat system support services operating correctly. This can include the probability of detection and tracking, probability of hazard engagement, probability of target designation, or a probability of engagement reliability. P_{CS} indicates a reliability of a communication support system operating. P_{REL} indicates a reliability of an interceptor missile. This can include a probability of missile reliability or a probability that a transport vehicle is disabled using the missile. P_{CTS} indicates a probability of a correct target selection. This can depend on targeting logic and on-board target selection logic. P_{FOV} indicates a probability of field of view containment. P_{DIV} indicates a probability of divert containment. A combination of P_{DIV} and P_{FOV} is sometimes called a probability of containment. Each of the probabilities are parameters of the mathematical model.

The operation 208 can include adjusting the probability models such that the data inputs, the metrics comprising the equation parameters, and the resulting outputs are on the defined common scale and common format. These adjustments are referred to as normalizing the effect. For example, if P_{ES1} for effect 1 includes parameters defined in terms of meters, and if P_{ES2} for effect 2 includes parameters defined in terms of feet, then normalizing these probability models would require the conversion of the distance parameters in one model to conform to the common distance scale and format used by the other (i.e., convert feet in P_{ES1} to meters).

The operation 210 can include storing the normalized effect model in a library of normalized effect models. The normalized effect models can be normalized to a same target (e.g., a common probability model) so that they can be combined and an outcome using multiple effects can be accurately simulated. For example, consider effects for mitigating harm from a missile. The effects can include cyber effects (e.g., jamming, hacking, or the like), or kinetic effects (e.g., an interceptor missile, a target replacement (forcing missile explosion by intercepting the missile with a substitute target), or the like). Each of the effects can be dependent on one or more systems operating properly. For example, a probability of interceptor success can be dependent on a tracking system operating properly, a detection system operating properly, and an engagement system operating properly. The probability of success of the effect can also be dependent on the missile being operational, being removed from a storage location, being loaded onto a carrier, being transported by the carrier to the launch site, being loaded into the launcher, launched, tracking to a target, detecting a target, and engaging a target. Each of these stages of the missile can have different models that can be combined to form an overall model of the missile deployment (the hazard deployment). An effect can be useful in one or more of any of the stages of the missile deployment.

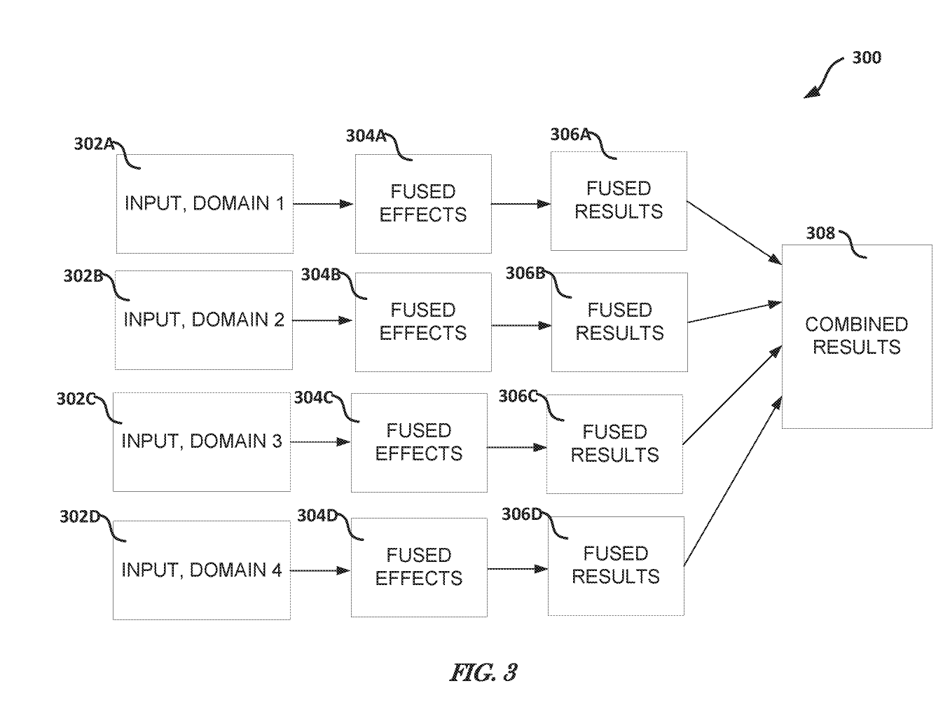

FIG. 3 illustrates, by way of example, a diagram of an embodiment of a method 300 for combining and simulating combinations of effects (sometimes called fusing). The method 300 includes receiving inputs 302A, 302B, 302C, and 302D. The inputs 302A-302D can be from different domains (e.g., environments). For example, a first domain can include air, a second domain can include water, a third domain can include land, and a fourth domain can include space.

The input 302A from an air domain can include data from an unmanned aerial vehicle, a manned aerial vehicle, or the like. The aerial vehicle can include one or more sensors that gather data regarding a condition in the air. Such sensors can include one or more of an optic sensor, a temperature sensor, a pressure sensor, electromagnetic sensor, liquid sensor, wind sensor, image sensor/camera, or the like.

The input 302B from a water domain can be from a boat, submarine, other manned or unmanned water vessel, or a monitoring station on water that can capture data. The water vessel (or another such platform as mentioned above) can include one or more sensors that gather data regarding a condition in or on the water. Such a sensor can include a turbidity sensor, a flow sensor, a temperature sensor, an optical sensor, a salinity sensor, or the like.

The input 302C from a land domain can be from a land vehicle or otherwise on the land. A sensor on the land can include a same or different sensor as those in the air domain or the water domain.

The input 302D from a space domain can be from a satellite or other object in space. The sensor in space can include a same or different sensor as those in the land, air, or water.

As previously discussed, effects can be from different domains. Effects in different domains can have different inputs that govern the operation of the effects. The effects from each domain can be fused 304A, 304B, 3040, and 304D. The inputs 302A-302D can inform the operation of the fused effects 304A-304D to produce simulation results 306A, 306B, 306C, and 306D. The results from each of the domains can then be fused, because the effects have been normalized to each other, to produce combined results 308.

The fused results 306A-306D and combined results 308 can include a probability, a confidence interval, and an indication of a target of the effect(s). The probability can indicate a likelihood that the effect(s) from the fused effects 304A-304D will exploit a vulnerability and mitigate at least a portion of harm caused by the hazard. The confidence interval can indicate how much variability there is in the probability of the results 308. The target can indicate the hazard (if there are multiple hazards) or a vulnerability of the hazard to be exploited by the effects.

The confidence interval can be determined by making changes to the input 302A-302D and recording the results. These simulations with changes in inputs are sometimes called Monte Carlo simulations. In Monte Carlo simulations, random samples of the inputs 302A-302D are chosen for operation of the simulation. The results from the random input values are used to generate the probability and the confidence interval. The average or a weighted average of the results from the Monte Carlo simulation can be used to determine a resultant probability. A variance, standard deviation, or some other measure of variability can be used as the confidence interval. The combined results 308 can be determined in a same or a different manner as the fused results 306A-306D except based on the fused results 306A-306D rather than the result of the effects 304A-304D.

The operation 214 can include providing a visualization of a geographic area, a computer network, a battlefield, one or more items or components (e.g., buildings, vehicles, roadways, waterways, or other assets), or the like that could be affected by the hazard. The visualization can be of the fused effects 304A-304D operation on the hazard. The operation 216 can include providing the combined results 308.

What follows is three example applications of embodiments. The Examples include missile defense, hurricane relief, and biological disaster response.

Example 1 is a detailed example for missile defense.

For operation 202, initial information can be available, but the details can be developed and refined throughout the process. The process can be iterative, and steps may require rework as new knowledge comes up with new use cases.

For operations 202, 204, and 206 one or more hazards, associated effects, and CONOPS or CONEMP can be identified or generated that describe the intended use of the effect against an initial list of hazards. For operation 206, it can be determined if the effect might be used against multiple hazards or multiple types of hazards. At operation 206, it can be determined if the effect might be used in conjunction with other effects, such as to increase efficacy.

Operation 202 can include documenting or developing a CONOP or concept of deployment, as applicable, to describe how the effect might be used against the hazard. Operation 202 can include documenting any known operational constraints and assumptions. Operations 202, 204, and 206 can include considering the use of one or more effects from different platforms and at different phases of the hazard kill chain. The operation 202 can include identifying any applicable deployment locations and schedules, and any applicable launch/target locations and schedules.

The operation 202 can include identifying at least some hazard information. The hazard information can include a hazard name and unique identifier, sites or site locations associated with the hazard (e.g., manufacturing sites, deployment sites, launch sites, or the like), hazard scenarios (full Hazard life cycle or subset), such as with process times and time lines, and hazard trajectories (e.g. to/from locations), as applicable.

The operation 204 can include identifying and characterizing the hazard vulnerability(s). The operation 204 can include identifying the corresponding hazard vulnerabilities against which the effect can be applied. For each vulnerability, the associated CONOPS and/or CONEMP for deploying the new effect can be identified at operation 204 or 206.

As previously discussed, an effect may be used against more than one hazard, and a given hazard may have multiple vulnerabilities. The operations 202, 204, and 206 can identify not only at the initially selected hazard, but also at additional hazards against which the effect may be applied. In operations 202 and 204 each unique hazard, vulnerability pair can be separately identified.

At operation 204, vulnerabilities associated with different stages of hazard deployment and activation scenarios can be identified. For example, a hazard that must be transported may have additional vulnerabilities that are associated with the transport system. At operation 204, a separate entry can be added to an effects library for each pairing of the effect to a unique hazard, vulnerability pair.

The operation 206 can include identifying subject matter experts (SME) for the effect and any other applicable associated effects. A purpose of the effects library can include providing a user with a selection of effects that can be either used, individually or combined, against an identified hazard, vulnerability pair. Note that each effect model equation (e.g., pDefeat equation) can be based on the pairing of a specific effect with a specific hazard, vulnerability pair. Other applicable hazards can be identified at the same time.

The operation 206 information associated with the effect can be identified. The information can include an effect name, a unique identifier, applicable sites, site locations associated with the effect (e.g., manufacturing sites, deployment sites, launch sites, or the like), effect scenarios with process times and time lines, effect trajectories (e.g., to/from locations), as applicable, effect constraints and limitations, or hazard states (e.g., one or more of the required state of the hazard and the state of the hazard upon successful application of the effect). Some effects work on the hazard indirectly (e.g., a Denial of Service (DoS) effect on a transport vehicle can applied to the transport vehicle and it affects the delivery of hazard(s) in its cargo).

The operation 206 can include identifying or generating a model for each effect and hazard, vulnerability pairing. A top-level model is defined in application Ser. No. 15/445,095 to P. Hershey, et al., titled “Method and Technique for Simulation and Integration of Multi-Domain Non-kinetic/Kinetic Systems (MATSIMS)”, filed 28 Feb. 2017. The top-level model can be the same for all effect and hazard, vulnerability pairings. The top-level parameters can usually be broken down into lower-level formulas with lower-level parameters. Each of those lower-level parameters has the potential for being broken down even further. The specific composition of those equations is dependent on the factors that influence the model for that specific effect against that specific hazard, vulnerability. Some of those factors include type of effect (e.g., kinetic, Electronic Warfare (EW), cyber, or the like), timing of effect (e.g., before or after launch, or specific phase of the hazard kill chain), architecture on which the equations and parameters are based, dependencies on other systems, or any additional assumptions.

Several models already exist for different effect/vulnerability pairings. Reuse of existing equations can help take advantage of the existing common probability model and software, keep model terms and vocabulary consistent, and take advantage of prior SME experience in deriving and defining models. If an existing model does not exist for an effect/vulnerability pairing, an equation can be generated. Use of SME when identifying/generating the model can help identify subtle differences in perspective or terminology that can influence the definition of the equation. The operation 206 can include identifying the model for the use of a single effect against a vulnerability or generating or identifying a corresponding model for the use of multiple instances of an effect against the vulnerability, if applicable.

The operation 206 can include expanding the definition of each parameter in the model to identify the source of the parameter and the use. For one or more parameters, one or more of the following can be identified at operation 206: parameter name, unique identifier, definition, source(s) of the default parameter values, a probability distribution, with associated parameter values, that represents the value, or range of values, for the parameter, source(s) of mission-specific parameter value changes, to include user (e.g., mission operator or analyst), static (cannot be changed), and dynamic (e.g., based on intelligence or other incoming information). The parameter values may, or may not, be different for each different effect and hazard vulnerability pairing.

The operation 206 can include identifying any constraints that are related to the use of the effect against each vulnerability. Note that constraints can influence the model. Examples of constraints are time, and/or phase of the kill chain during which the effect can be used, number of times an effect can be used/re-used, command and control or other required procedures, and associated latencies.

The operation 206 can include SME review. The SME review can include reviewing and finalizing the draft model by one or more SMEs. Note that the implementation of the effect and the experience gained by utilizing the effect can result in an updated model that takes into account lessons learned.

The operation 208 can include generating a re-usable effect model that can combined with other effect models. The operation 208 can simplify software to operate the models, take advantage of re-use, and enhance understanding and trust of the simulations performed at operation 212. The operation 208 can include verifying that the parameters of the effect conform to the existing Common Probability Model (CPM). The operation 208 can include normalizing the parameter values so that they are consistent within the models. The operation 208 can include analyzing each parameter to determine the needed level of fidelity (e.g., deviation or variance). The operation 208 can include assessing a confidence level and variability of the parameter. The operation 208 can include consulting SMEs to upgrade the model to define and support additional capabilities.

The operation 208 can include updating a Stochastic Math Model (SMM), as needed, to enhance the CPM to cover the effect, hazard, or vulnerability. After the SMM has been updated, the CPM enhancements can be available for use with other effects and hazards.

A stochastic model is a tool for estimating probability distributions of potential outcomes by allowing for random variation in one or more inputs over time. The random variation is usually based on fluctuations observed in historical data for a selected period using standard time-series techniques.

The operation 210 can include storing the normalized effect model in a database of hazards, vulnerabilities, and effects. The operation 210 can include updating the libraries and configuration files in the database to integrate the effect (or combination of effects) into the models in the database.

The operation 210 can include updating the normalized models to include any new parameters associated with the new effect so that the effects models can be combined. The operation 210 can include adding any new scenario logic to a simulator that may be required to perform the operation 212. The operation 210 can include updating the parameters in a scenario definition input file to reflect the new parameter values associated with the effect. Example parameters are effect name, effect identifier, effect type, and associated probability model. The operation 210 can include updating the scenario generation logic to enable the creation of scenarios that demonstrate any new simulation threads driven by the Concept of Operations (CONOPS) and Concept of Employment (CONEMP) for the effect.

Updating the effects library can include adding an entry for each new effect/vulnerability pairing. Note that the introduction of an effect against one hazard type may result in an opportunity to use that same effect against other hazards. The probability of defeat (the result of the model simulation) may, or may not, differ for each effect/hazard vulnerability pairing. One or more of the following parameters, as a minimum, can be entered for each entry in the effects library: effect name or unique identifier, hazard name or unique identifier, vulnerability against which the effect is targeted, effect type (e.g., kinetic, EW, cyber, or the like), phase(s) of employment during which the effect can be used against the vulnerability, or the like.

Additional information related to the deployment of an effect can support operational decisions to use, or not to use, the effect. An example of additional information is the results of a failure mode effects analysis (FMEA), which characterizes the effect and associated vulnerability in greater detail.

The parameters of a model can come from multiple sources. The parameters of the model can have varying degrees of volatility. Volatility indicates how frequently the parameter values change. The probability distributions, to be input to the model for the effect, can be updated in the library. These different parameter distributions may be stored in different locations within the system. For example, static parameters, which rarely, if ever, change, are usually stored in the library, user-selectable parameters can be configured as part of a user interface, with defaults stored in the library, dynamic parameters, such as locations based on intelligence Surveillance and Reconnaissance (ISR), can be ingested dynamically as they are received as input.

The operation 214 can include providing a map visualization of scenarios and scenario results, and a graphical user interface (GUI) for the input of simulation commands. The map and GUI can be tailored to a given scenario via the use of configuration files. The operation 214 can include integrating the input and/or output of any effect simulators with the map visualization or other GUI. The operation 214 can include updating the effects library configuration file to display any new user configurable parameters.

As previously discussed, the operation 216 can be produced using a Monte Carlo simulation at operation 212. The operation 216 can include combining results from multiple simulations (e.g., Monte Carlo simulations).

At some point in the method, the method 200 can include verifying or updating the model or simulation of the model. The model(s) were reviewed (e.g., by the SMEs) at operation 206, but more can be known about the simulation or model at some time during the method 200. For example, by running the simulation(s), additional details regarding the effect can be gained by simulating the model and monitoring operation. Additional information or errors in the models can be determined from analysis of the results (e.g., by the SME). The model(s) can be updated accordingly.

Verification of the models can include test cases to verify that one or more of the default input values produce a result value that meets the expected value, input parameter values that test boundary conditions produce model values that meet the expected values, and the use of the effect in combination with another effect produces a model value that meets the expected value, or the like.

The verification of the models can help establish and maintain user trust in both the method and/or implemented algorithm and its results. Saving and archiving documentation that captures the results of the verification activities can help preserve user trust. The documentation can include, as a minimum, detailed model equations, with associated definitions, descriptions, or other related documentation, or as “executed” verification test procedure and test report.

The operation 218 can include comparing, for different combinations of effects or single effects, the probabilities and confidence intervals provided at operation 216. The operation 218 can include producing, for each vulnerability, a list of effects or combinations of effects. The list can include the effects by probability in descending order. The priority of the effect or combination of effects can be based on the number of vulnerabilities that the effect exploits, the probability of the effect mitigating the hazard, the size of the confidence interval (a larger confidence interval being associated with a lower confidence in the provided probability), the importance of exploiting the vulnerability (e.g., the CONOPS or CONEMP), a combination thereof, or the like. The operation 220 can include deploying the effect or combination of effects determined to be associated with the highest priority.

### Example 2: Disaster Recovery—Hurricane Response

For operation 202, a radar or other weather system can be used to identify a hurricane. The operation 204 can include identifying an eye of the hurricane. The operation 206 can include identifying and characterizing a cloud seeding technique that exploits the calm weather experienced in the eye. A CONEMP can be based on a probabilistic weather model that considers the strength, expected damage, and whether infrastructure will remain available during the hurricane.

For operation 202, the hazard and affected system can have multiple phases. First, the infrastructure can be available, then the infrastructure can be reached by workers, the power can be on, goods can reach the infrastructure, the port can be open, ships can get in, loaded ships can get back out, or the like.

For operation 206, the co-locations of all these stages in the supply chain can be important for this effect. The characterization of the effect (e.g., the model) can include weather models, past data on hurricane strength, damage likeliness, or the like. At operation 208, the model can be expressed in standard format, where each phase and step can have an underlying probability model (or models) which can result in a binomial yes/no answer determining the outcome of the step.

At operation 210, the probability model(s), can be stored in the libraries, and the configuration files updated with the configuration for the new analysis. At operation 212, data from external simulators, such as weather models, can be integrated into the simulation.

### Example 3: Biological—Illness Recovery

For a generic system, the operations 202, 204, and 206 can include determining the actor (hazard), what is being acted on (the vulnerability), and how it will be affected (the effect). For example, in a hospital, the actor can be an unknown virus. The affected system can be the human body. The concept of employment can be based on a probabilistic treatment model to include the symptoms, the present and expected health condition of the patient, the available medicine(s) treat the virus, and the predicted recovery time of the patient.

The hazard can be carried out in multiple phases. First, that the patient's body can be exposed to the virus. Next, the patient can begin to exhibit symptoms, such as runny nose, sneezing, or stiffness. Then, the patient can develop a fever, indicating a definite infection. The patient can go to a doctor for diagnosis (identification of the hazard). Based on the diagnosis, the doctor can prescribe possible drugs (e.g., the effects) to counter the hazard (the virus in this example). The CONEMP can be that the patient returns from a trip where they were exposed to a virus in the confines of the plane. Symptoms started the next day and became severe by evening, at which time they went to the emergency room (ER) for treatment. The ER doctor can then use the method 200 to diagnose and treat the illness.

The vulnerability in this example can include the virus's susceptibility to antibodies or other virus-resistant mechanism. The example effects in this case are drugs, food, sleep, isolation, cleanliness, a combination thereof, or the like; but could apply to any other illness hazard. For this biology example, the model can define how well various types of medicines have worked against similar viruses. Parameters of the model can include a state of patient's heath at time of infection, patient's immunizations, historical success statistics for each type of medicine considered, or the like.

At operation 208, the probability model can be expressed in a common format, where each phase and step can have an underlying probability model (or models) which would result in a binomial yes/no answer determining the outcome of the step. In other words, for each medicine or other treatment (sometimes called an effect), all parameters can be expressed in the same terms so that an exact comparison and evaluation can be accomplished.

The normalized probability models, for all medicines considered to counter the illness, may be placed in the library at operation 210. Related configuration files can be updated at operation 210. If the models and configuration files are already stored in the library repository, then no action need be taken at operation 210 in this example. Otherwise, the new or updated model can be encoded into the library, and the configuration files can be updated with the configuration for the new analysis.

Operation 212 can include using data from external simulators, such as medical treatment models. The operation 214 can include tailoring the visualization to fit the scenario.

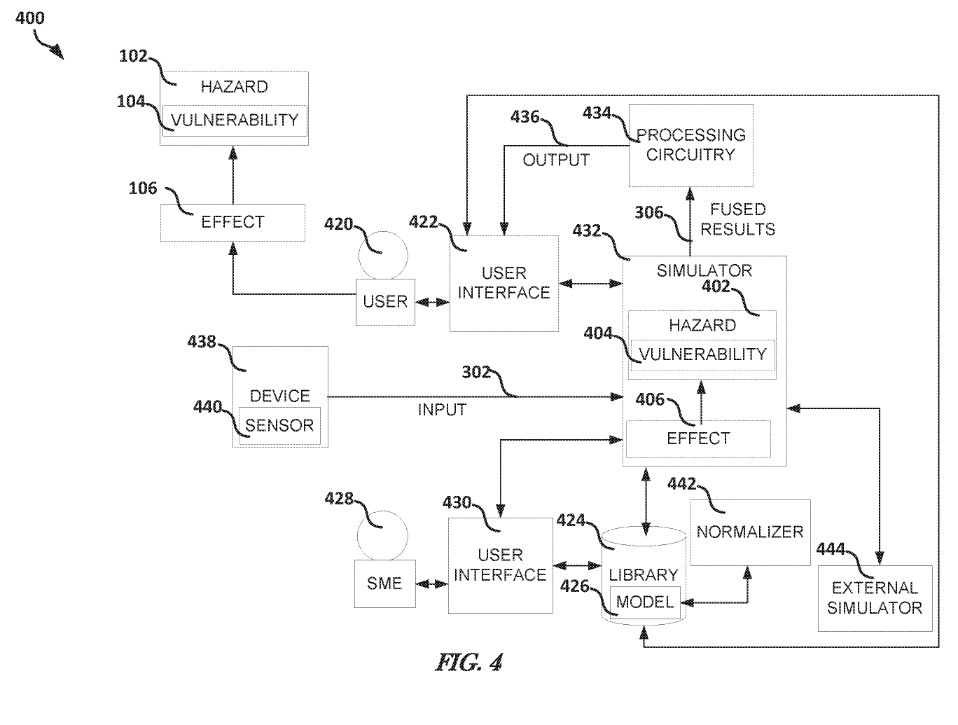

FIG. 4 illustrates, by way of example, a diagram of an embodiment of a system 400 for effect analysis, prioritization, deployment, or a combination thereof. The system 400 as illustrated includes the hazard 102, vulnerability 104, effect 106, input 302, simulated hazard 402, simulated vulnerability 404, simulated effect 406, user 420, user interface 422, model library 424, model 426, SME 428, user interface 430, simulator 432, processing circuitry 434, device 438, sensor 440, and a normalizer 442. Some of the illustrated elements of system 400 may be optional and desirable in some embodiments while not necessarily in others. Thus, not all the illustrated elements are necessarily required and/or used in all embodiments. For example, in an automated implementation, user 420 and/or SME 428 may not be involved.

The user 420 can interact with the user interface 422, such as to change a model 426, generate the model 426, execute the model 426, review the model 426, or the like. The user 420 is anyone or anything that can interact with the model 426, such as to make the simulator 432 to execute the model 426 and generate the results 306.

The user interface 422 is implemented by a display that provides a computer-based input or output mechanism. Through the user interface 422, the user can view results of simulations, interact with a visualization of the simulation, alter a model, execute a model, or the like.

The library 424 stores the normalized models 426 and other information corresponding to executing a simulation of one or more models 426. The library 424 can be accessible by either of the user interfaces 422, 430 or the simulator 432.

The SME 428 is an expert regarding a particular effect 106, 406 and its influence on the hazard 102, 402. The SME 428 can understand, mathematically or physically, how the effect mitigates the damage of the hazard 402 by exploiting the vulnerability 404. The SMF 428 can perform similar operations as the user 420 through the user interface 430.

The user interface 430 is implemented by a display that provides a computer-based input or output mechanism. Through the user interface 430, the SME 428 can view results of simulations, interact with a visualization of the simulation, alter a model, execute a model, or the like. The user 420 or the SME 428 can perform the operations 202, 204, or 206 through the user interface 422, 430. In some embodiments, the user 420 may be the expert (SME 428) and the system 400 may comprise a single user interface 422/430.

The simulator 432 can execute the model 426 and tabulate results of the execution. The simulator 432 can perform a Monte Carlo simulation of the model 426, such as to determine a confidence interval associated with a probability of the effect 106, 406 mitigating damage caused by the hazard 102, 402. The simulator 432 can receive input from the device 438 (e.g., a sensor 440 of the device 438), a predefined input from the sensor 440 that can be stored in the library 424 as a configuration file, an external simulator 444 that simulates the sensor 440 or other component that is part of the simulation, such as the hazard 402, the vulnerability 404, or the effect 406, a configuration file in the library 424 that details a value for a parameter of the model 426, the user interface 422, 430 through which a user can specify the model 426, external components from which to receive input, parameters of the model 426, a number of simulations to perform, combinations of effects, or the like. The sensor 440 can include an optic sensor, a temperature sensor, a pressure sensor, electromagnetic sensor, liquid sensor, wind sensor, or the like, a turbidity sensor, a flow sensor, a salinity sensor, or the like.

The simulator 432 can be implemented using electrical or electronic components, such as those similar to or same as the processing circuitry 434. The simulator 432 can execute the model 426 to generate one or more of the simulated hazard 402, simulated vulnerability 404, or the simulated effect 406. One or more of the simulated hazard 402 and the simulated vulnerability 404 can be provided by output from the external simulator 444.

The simulator 432 can generate the fused results 306. The processing circuitry 434 can operate on the fused results 306 to generate the output 436. The output 436 can include the combined results 308, a prioritized list of effects, or the like. The processing circuitry 434 can include electrical or electronic components configured to perform operations on the results 306. The electrical or electronic components can include one or more resistors, transistors, capacitors, inductors, diodes, power supplies, processors (e.g., a central processing unit (CPU), an application specific integrated circuit (ASIC), field programmable gate array (FPGA), graphics processing unit (GPU), or the like), converters (e.g., analog to digital converters (ADCs) or digital to analog converters (DACs)), diodes, regulators, oscillators, logic gates (e.g., AND, OR, XOR, negate, buffer, or the like), switches, multiplexers, or the like. The simulator 432 can perform the operation 212. The processing circuitry 434 can perform one or more of the operations 216, 218.

The normalizer 442 can adjust a model or parameter to be consistent with a standard model. The normalizer 442 can perform the operation 208. The normalizer 442 can determine a statistical confidence interval for a given parameter, group of parameters, model, or the like. An original confidence interval can be determined based on a priori historical device/sensor input. The normalizer 442 can be implemented using electrical or electronic components, such as those similar to or same as the processing circuitry 434. In some embodiments, the effect(s) may be deployed to mitigate the hazard, (e.g., based on the simulated combined effect and a combined confidence level).

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) be driven by cost and time considerations.

Accordingly, the term “hardware-implemented module” is understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, FPGA or ASIC.

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

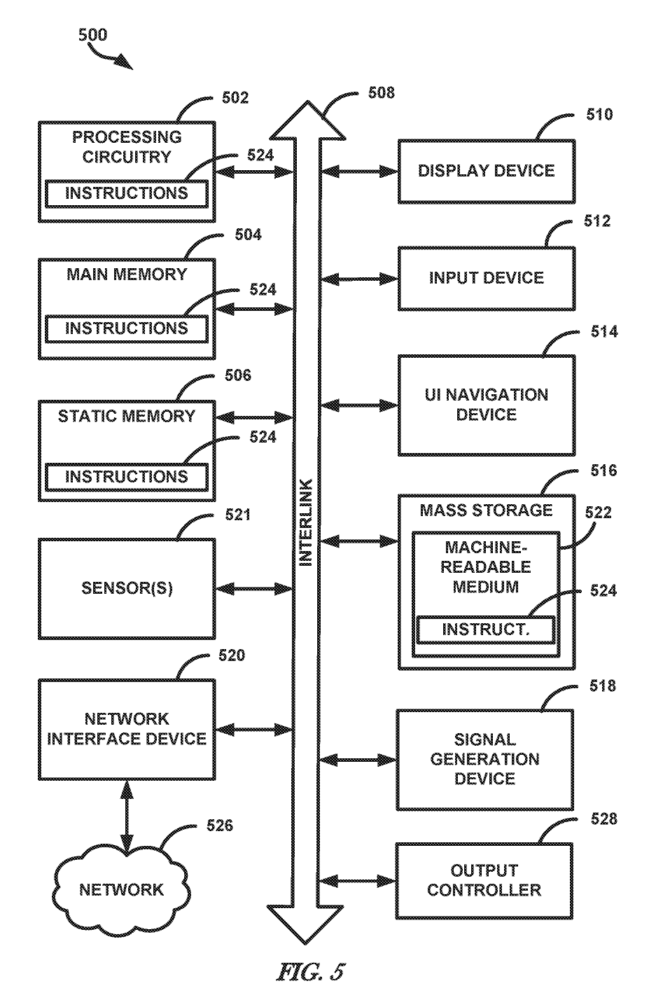

FIG. 5 illustrates, by way of example, a block diagram of an embodiment of a machine in the example form of a computer system 500 within which instructions, for causing the machine to perform any one or more of the methodologies discussed herein, may be executed. In one or more embodiments, the effect 106, device 438, user interface 422, 430, simulator 432, library 424, external simulator 444, or processing circuitry 434, or other device or component discussed herein can include one or more items of the system 500. In one or more embodiments, the effect 106, device 438, user interface 422, 430, simulator 432, library 424, external simulator 444, or processing circuitry 434, or other device discussed herein can be implemented using one or more items of the system 500.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a CPU, GPU, or both), a main memory 504 and a static memory 506, which communicate with each other via a bus 508. The computer system 500 may further include a video display unit 510 (e.g., a liquid crystal display (LCD), light emitting diode (LED), or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker), a network interface device 520, and sensor(s) 521.

### Machine-Readable Medium

The disk drive unit 516 includes a machine-readable medium 522 on which is stored one or more sets of instructions 524 and data structures (e.g., software) embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 524 may further be transmitted or received over a communications network 526 using a transmission medium. The instructions 524 may be transmitted using the network interface device 520 and any one of a number of well-known transfer protocols (e.g., hypertext transfer protocol (HTTP), such as HTTP secure (HTTPS)). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Additional Notes and Examples

Example 1 can include a method for responding to a hazard, the method comprising identifying at least two effects that, with some probability, at least partially mitigate the hazard, identifying one or more vulnerabilities of the hazard that are the target for an effect of the identified effects, for each hazard, vulnerability pair, identifying a respective hazard model that simulates a state of the hazard in response to the effect, identifying effect models that simulate the respective effects, normalizing each of the identified effect models to a common model and determining a confidence level for each parameter of each normalized model, and simulating combinations of effects by combining normalized models and recording their combined effect on the hazard and a corresponding combined confidence level for the normalized models.

In Example 2, Example 1 can further include or use deploying the effects to at least partially mitigate the hazard based on the simulated combined effect and the combined confidence level.

In Example 3, at least one of Examples 1-2 can further include, wherein the hazard is a physical hazard to a geographical area or person.

In Example 4, at least one of Examples 1-3 can further include, wherein simulating combinations of effects includes simulating at each respective step of the hazard, whether the respective step will succeed or fail and an associated confidence level of success or failure in light of the combination of effects.

In Example 5, Example 4 can further include, wherein each of the normalized models provides a binomial result.

In Example 6, at least one of Examples 4-5 can further include, wherein simulating combinations of effects by combining normalized models and recording their combined effect on the hazard and a corresponding combined confidence level include simulating combinations of effects on different steps of the hazard.

In Example 7, Example 6 can further include, wherein the confidence level is determined using Monte Carlo simulations and tabulating results of the simulations.

In Example 8, at least one of Examples 1-7 can further include, wherein characterizing the effect includes identifying an effect name, a location of the effect, process times and time lines of the effect, constraints and limitations of the effect, and a state of the hazard after the effect is successfully deployed against hazard.

In Example 9, Example 8 can further include, wherein characterizing the effect includes identifying a model for each step of setting up and deploying the effect and simulating the combinations of effects includes simulating each step of setting up and deploying the effects.

In Example 10, Example 9 can further include characterizing the hazard including identifying a hazard name, a location of the hazard, steps of the hazard, and a target of the hazard.

In Example 11, Example 10 can further include, wherein characterizing the hazard includes identifying a model for each step of setting up and deploying the hazard and simulating the combinations of effects includes simulating each step of setting up and deploying the hazard with the effects incident on the hazard.

In Example 12, at least one of Examples 1-11 can further include, wherein the identified effects include a cyber effect.

Example 13 includes at least one non-transitory machine-readable medium including instructions that, when executed by a machine, configure the machine to perform operations comprising, identifying at least two effects that, with some probability, at least partially mitigate the hazard, identifying one or more vulnerabilities of the hazard that are the target for an effect of the identified effects, for each hazard, vulnerability pair, identifying a respective hazard model that simulates a state of the hazard in response to the effect, identifying effect models that simulate the respective effects, normalizing each of the identified effect models to a common model and determining a confidence level for each parameter of each normalized model, and simulating combinations of effects by combining normalized models and recording their combined effect on the hazard and a corresponding combined confidence level for the normalized models.

In Example 14, Example 13 can further include, wherein the hazard is a physical hazard to a geographical area or person.

In Example 15, at least one of Examples 13-14 can further include, wherein simulating combinations of effects includes simulating at each respective step of the hazard, whether the respective step will succeed or fail and an associated confidence level of success or failure in light of the combination of effects.

In Example 16, Example 15 can further include, wherein each of the normalized models provides a binomial result.

In Example 17, at least one of Examples 15-16 can further include, wherein simulating combinations of effects by combining normalized models and recording their combined effect on the hazard and a corresponding combined confidence level include simulating combinations of effects on different steps of the hazard.

In Example 18, Example 17 can further include, wherein the confidence level is determined using Monte Carlo simulations and tabulating results of the simulations.

In Example 19, at least one of Examples 13-18 can further include, wherein characterizing the effect includes identifying an effect name, a location of the effect, process times and time lines of the effect, constraints and limitations of the effect, and a state of the hazard after the effect is successfully deployed against hazard.

In Example 20, Example 19 can further include, wherein characterizing the effect includes identifying a model for each step of setting up and deploying the effect and simulating the combinations of effects includes simulating each step of setting up and deploying the effects.

In Example 21, Example 20 can further include characterizing the hazard including identifying a hazard name, a location of the hazard, steps of the hazard, and a target of the hazard.

In Example 22, Example 21 can further include, wherein characterizing the hazard includes identifying a model for each step of setting up and deploying the hazard and simulating the combinations of effects includes simulating each step of setting up and deploying the hazard with the effects incident on the hazard.

In Example 23, at least one of Examples 13-22 can further include, wherein the identified effects include a cyber effect.

Example 24 includes a system for hazard mitigation, the system comprising: a model library including normalized effects models and configuration files stored thereon, the normalized effects models indicating how a corresponding effect or combination of effects exploits one or more vulnerabilities of a hazard to mitigate damage caused by the hazard, a user interface through which a user identifies one or more vulnerabilities of the hazard that are the target for an effect of the effects, for each hazard, vulnerability pair, identifies a respective hazard model that simulates a state of the hazard in response to the effect, and identifies effect models that simulate the respective effects, normalizer circuitry to normalize each of the identified effects models to a common model and determine a confidence level for each parameter of each normalized model, and simulator circuitry to receive a normalized effects model corresponding to at least two effects that, with some probability, at least partially mitigate the hazard, and simulate combinations of effects by combining normalized effect models and recording their combined effect on the hazard and a corresponding combined confidence level for the normalized models.

In Example 25, Example 24 can further include, wherein the hazard is a physical hazard to a geographical area or person.

In Example 26, at least one of Examples 24-25 can further include, wherein simulating combinations of effects includes simulating at each respective step of the hazard, whether the respective step will succeed or fail and an associated confidence level of success or failure in light of the combination of effects.

In Example 27, Example 26 can further include, wherein each of the normalized models provides a binomial result.

In Example 28, at least one of Examples 26-27 can further include, wherein simulating combinations of effects by combining normalized models and recording their combined effect on the hazard and a corresponding combined confidence level include simulating combinations of effects on different steps of the hazard.

In Example 29, Example 28 can further include, wherein the confidence level is determined using Monte Carlo simulations and tabulating results of the simulations.

In Example 30, at least one of Examples 24-29 can further include, wherein characterizing the effect includes identifying an effect name, a location of the effect, process times and time lines of the effect, constraints and limitations of the effect, and a state of the hazard after the effect is successfully deployed against hazard.

In Example 31, Example 30 can further include, wherein characterizing the effect includes identifying a model for each step of setting up and deploying the effect and simulating the combinations of effects includes simulating each step of setting up and deploying the effects.

In Example 32, at least one of Examples 24-31 can further include characterizing the hazard including identifying a hazard name, a location of the hazard, steps of the hazard, and a target of the hazard.

In Example 33, Example 32 can further include, wherein characterizing the hazard includes identifying a model for each step of setting up and deploying the hazard and simulating the combinations of effects includes simulating each step of setting up and deploying the hazard with the effects incident on the hazard.

In Example 34, at least one of Examples 24-33 can further include, wherein the identified effects include a cyber effect.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method for responding to a hazard, the method comprising:
identifying at least two effects that, with some probability, at least partially mitigate the hazard;
identifying one or more vulnerabilities of the hazard that are the target for an effect of the identified effects;
for each hazard, vulnerability pair, identifying a respective hazard model that simulates a state of the hazard in response to the effect;
identifying effect models that simulate the respective effects;
normalizing each of the identified effect models to a common model and determining a confidence level for each parameter of each normalized model; and
simulating combinations of effects by combining normalized models and recording their combined effect on the hazard and a corresponding combined confidence level for the normalized models.

2. The method of claim 1, further comprising deploying the effects to at least partially mitigate the hazard based on the simulated combined effect and the combined confidence level.

3. The method of claim 1, wherein the hazard is a physical hazard to a geographical area or person.

4. The method of claim 1, wherein simulating combinations of effects includes simulating at each respective step of the hazard, whether the respective step will succeed or fail and an associated confidence level of success or failure in light of the combination of effects.

5. The method of claim 4, wherein each of the normalized models provides a binomial result.

6. The method of claim 4, wherein simulating combinations of effects by combining normalized models and recording their combined effect on the hazard and a corresponding combined confidence level include simulating combinations of effects on different steps of the hazard.

7. The method of claim 6, wherein the confidence level is determined using Monte Carlo simulations and tabulating results of the simulations.

8. The method of claim 1, wherein characterizing the effect includes identifying an effect name, a location of the effect, process times and time lines of the effect, constraints and limitations of the effect, and a state of the hazard after the effect is successfully deployed against hazard.

9. The method of claim 8, wherein characterizing the effect includes identifying a model for each step of setting up and deploying the effect and simulating the combinations of effects includes simulating each step of setting up and deploying the effects.

10. The method of claim 9, further comprising characterizing the hazard including identifying a hazard name, a location of the hazard, steps of the hazard, and a target of the hazard.

11. The method of claim 10, wherein characterizing the hazard includes identifying a model for each step of setting up and deploying the hazard and simulating the combinations of effects includes simulating each step of setting up and deploying the hazard with the effects incident on the hazard.

12. The method of claim 1, wherein the identified effects include a cyber effect.

13. A non-transitory machine-readable medium including instructions that, when executed by a machine, configure the machine to perform operations comprising:
identifying at least two effects that, with some probability, at least partially mitigate the hazard;
identifying one or more vulnerabilities of the hazard that are the target for an effect of the identified effects;
for each hazard, vulnerability pair, identifying a respective hazard model that simulates a state of the hazard in response to the effect;
identifying effect models that simulate the respective effects;
normalizing each of the identified effect models to a common model and determining a confidence level for each parameter of each normalized model; and
simulating combinations of effects by combining normalized models and recording their combined effect on the hazard and a corresponding combined confidence level for the normalized models.

14. The non-transitory machine-readable medium of claim 13, wherein the hazard is a physical hazard to a geographical area or person.

15. The non-transitory machine-readable medium of claim 13, wherein simulating combinations of effects includes simulating at each respective step of the hazard, whether the respective step will succeed or fail and an associated confidence level of success or failure in light of the combination of effects.

16. The non-transitory machine-readable medium of claim 15, wherein each of the normalized models provides a binomial result.

17. The non-transitory machine-readable medium of claim 15, wherein simulating combinations of effects by combining normalized models and recording their combined effect on the hazard and a corresponding combined confidence level include simulating combinations of effects on different steps of the hazard.

18. The non-transitory machine-readable medium of claim 17, wherein the confidence level is determined using Monte Carlo simulations and tabulating results of the simulations.

19. A system for hazard mitigation, the system comprising;
a model library including normalized effects models and configuration files stored thereon, the normalized effects models indicating how a corresponding effect or combination of effects exploits one or more vulnerabilities of a hazard to mitigate damage caused by the hazard;
a user interface through which a user identifies one or more vulnerabilities of the hazard that are the target for an effect of the effects, for each hazard, vulnerability pair, identifies a respective hazard model that simulates a state of the hazard in response to the effect, and identifies effect models that simulate the respective effects;
normalizer circuitry to normalize each of the identified effects models to a common model and determine a confidence level for each parameter of each normalized model; and
simulator circuitry to receive a normalized effects model corresponding to at least two effects that, with some probability, at least partially mitigate the hazard, and simulate combinations of effects by combining normalized effect models and recording their combined effect on the hazard and a corresponding combined confidence level for the normalized models.

20. The system of claim 19, wherein the identified effects include a cyber effect.
